(19) United States
(12) Patent Application Publication
(10) Pub. No.: US 2010/0271286 A1
(43) Pub. Date: Oct. 28, 2010

(54) METHOD FOR PROVIDING A VIDEO PLAYBACK DEVICE WITH A TELEVISION WALL FUNCTION, AND ASSOCIATED VIDEO PLAYBACK DEVICE AND ASSOCIATED INTEGRATED CIRCUIT

(76) Inventors: Min Li, Anqin City (CN); Xutong Hu, Hefei City (CN)

Correspondence Address: NORTH AMERICA INTELLECTUAL PROPERTY CORPORATION, P.O. BOX 506, MERRIFIELD, VA, 22116, US

(21) Appl. No.: 12/489,415

(22) Filed: Jun. 22, 2009

(30) Foreign Application Priority Data
Apr. 22, 2009 (CN) 200910135068.X

(51) Int. Cl. G09G 5/00

(52) U.S. Cl. 345/1.3

(57) ABSTRACT

A method for providing a video playback device with a television (TV) wall function includes providing a user interface for setting the video playback device to correspond to a specific display area of a plurality of individual display areas of a TV wall, and utilizing the video playback device to derive a partial image of an enlarged image to be displayed by the TV wall, in order to display the partial image on the specific display area. An associated video playback device and an associated integrated circuit (IC) are further provided.

### BACKGROUND

The present invention relates to setting up a television (TV) wall, and more particularly, to a method for providing a video playback device with a TV wall function, and an associated video playback device and an associated integrated circuit (IC).

Please refer to FIG. 1, which illustrates a splitter 14 coupled between a video source 12 and a plurality of display devices forming a TV wall according to the related art, where the display devices in this example are substantially TVs 16-1, 16-2, . . . , and 16-n utilized as monitors, and a TV wall system 10 is thereby formed with the video source 12, the splitter 14, and the TVs 16-1, 16-2, . . . , and 16-n. The video source 12 outputs image data representing a source image. According to the related art, in order to display an enlarged image of the source image by utilizing the TV wall formed with the TVs 16-1, 16-2, . . . , and 16-n, a splitter such as the splitter 14 is usually required for generating and outputting respective image data to the TVs 16-1, 16-2, . . . , and 16-n, where the image data output from the splitter 14 to one of the TVs represents a corresponding partial image of the enlarged image.

As mentioned, a splitter such as the splitter 14 shown in FIG. 1 is an essential device for setting up a TV wall according to the related art. However, such a splitter is expensive and is not handy. In addition, from the splitter 14 to the TVs 16-1, 16-2, . . . , and 16-n, connections corresponding to a star-style topology are required, where long cables for most of these connections are typically needed, causing complexity and inconvenience when setting up the TV wall.

### SUMMARY

It is therefore an objective of the claimed invention to provide a method for providing a video playback device with a television (TV) wall function, and to provide an associated video playback device and an associated integrated circuit (IC), in order to solve the above-mentioned problem.

An exemplary embodiment of a method for providing a video playback device with a TV wall function comprises: providing a user interface for setting the video playback device to correspond to a specific display area of a plurality of individual display areas of a TV wall; and utilizing the video playback device to derive a partial image of an enlarged image to be displayed by the TV wall, in order to display the partial image on the specific display area.

An exemplary embodiment of a video playback device provided with a TV wall function comprises a controller and a video processing module. The controller is arranged to provide a user interface, wherein the user interface is utilized for setting the video playback device to correspond to a specific display area of a plurality of individual display areas of a TV wall. In addition, the video processing module arranged to derive a partial image of an enlarged image to be displayed by the TV wall, in order to display the partial image on the specific display area.

An exemplary embodiment of an IC for controlling a video playback device and providing the video playback device with a TV wall function comprises a controller and a video processing module. The controller is arranged to provide a user interface, wherein the user interface is utilized for setting the video playback device to correspond to a specific display area of a plurality of individual display areas of a TV wall. In addition, the video processing module arranged to derive a partial image of an enlarged image to be displayed by the TV wall, in order to display the partial image on the specific display area.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a splitter coupled between a video source and a plurality of display devices forming a television (TV) wall according to the related art.

FIG. 2 is a video playback device provided with a TV wall function according to a first embodiment of the present invention.

FIG. 3 is a flowchart of a method for providing a video playback device with a TV wall function according to one embodiment of the present invention.

FIG. 4 and FIG. 5 illustrate examples of On-Screen Display (OSD) contents to be displayed on a screen when utilizing the method shown in FIG. 3 to setup at least a portion of a TV wall in the embodiment shown in FIG. 3.

FIG. 6 illustrates an example of an enlarged image to be displayed by the TV wall in the embodiment shown in FIG. 3.

FIG. 7 illustrates examples of partial images of the enlarged image shown in FIG. 6 according to the embodiment shown in FIG. 3.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

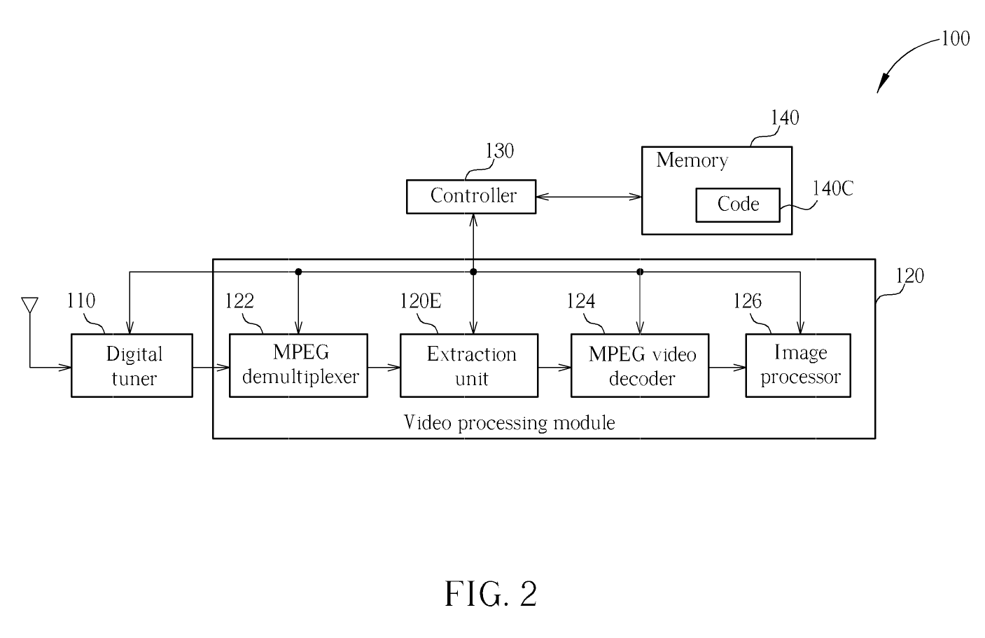

Please refer to FIG. 2. FIG. 2 is a diagram of a video playback device 100 provided with a television (TV) wall function according to a first embodiment of the present invention. The video playback device 100 of this embodiment is a multi-channel broadcasting program receiver comprising a digital tuner 110, a video processing module 120, a controller 130 and a memory. In this embodiment, the controller 130 is a micro control unit (MCU) executing a code 140C stored in a memory 140. According to a variation of this embodiment, the controller 130 can be a hardware controller with the code 140C embedded therein. That is, whether a program code such as the code 140C is stored in a memory such as the memory 140 depends on different variations of this embodiment.

According to this embodiment, the digital tuner 110 is arranged to select one of a plurality of channels, and the video processing module 120 is arranged to decode according to a selection of the digital tuner 110. In addition, the controller 130 is arranged to provide a user with a channel switching service. When the TV wall function mentioned above is disabled, the video playback device 100 of this embodiment substantially plays a role of a normal multi-channel broadcasting program receiver such as a conventional digital TV receiver on the market.

According to the first embodiment, the video processing module 120 comprises an MPEG demultiplexer 122, an MPEG video decoder 124 and an image processor 126, and further comprises an extraction unit 120E, wherein when the TV wall function mentioned above is disabled, the controller 130 controls the extraction unit 120E to bypass a signal from the MPEG demultiplexer 122 to the MPEG video decoder 124. According to a variation of this embodiment, the extraction unit 120E can be integrated into the MPEG video decoder 124.

In this embodiment, the MPEG demultiplexer 122 is arranged to demultiplex video content and audio content of a program on the channel selected by the digital tuner 110. In addition, the MPEG video decoder 124 is arranged to decode the video content demultiplexed by the MPEG demultiplexer 122, and more particularly, to perform MPEG-decoding on the video content. Additionally, the image processor 126 may further perform image processing on the decoded video content to be displayed. Please note that whether an on screen display (OSD) processing circuit is utilized for processing the video content to be displayed depends on different variations of this embodiment.

Regarding the TV wall function mentioned above, the controller 130 is further arranged to provide a user interface for setting the video playback device 100 to correspond to a specific display area of a plurality of individual display areas of a TV wall. More particularly, when the TV wall function is enabled, the controller 130 together with the video processing module 120 operate in a TV wall mode, and a corresponding display device receiving video data from the video playback device 100 displays a corresponding partial image of the an enlarged image to be displayed by the TV wall.

According to this embodiment, when the TV wall function mentioned above is enabled, the controller 130 controls the extraction unit 120E to input selected video data representing the corresponding partial image into the MPEG video decoder 124, and further controls the MPEG video decoder 124 to decode the selected video data in order to generate the corresponding partial image. More particularly, the MPEG video decoder 124 derives a non-enlarged version of the corresponding partial image directly from the selected video data, and the controller 130 controls the image processor 126 to scale up the non-enlarged version of the corresponding partial image, in order to derive the corresponding partial image of the enlarged image to be displayed by the TV wall.

Typically, a plurality of copies of the video playback device 100 and a plurality of copies of the corresponding display device mentioned above are utilized for setting up the TV wall. A user may utilize the user interface mentioned above to properly set each copy of the video playback device 100 to correspond to which specific portion of the TV wall (e.g., an upper left portion, an upper right portion, a lower left portion or a lower right portion of the TV wall), so each copy of the corresponding display device may faithfully play the role of that specific portion of the TV wall. As a result, the display areas of the copies of the corresponding display device (i.e., the aforementioned individual display areas of the TV wall) display partial images of the enlarged image to be displayed by the TV wall, respectively.

According to the first embodiment, the corresponding display device is an external device outside the video playback device 100, while the video playback device 100 is a video source of the corresponding display device comprising the specific display area. This is only for illustrative purposes, and is not meant to be a limitation of the present invention. According to a variation of this embodiment, a display module can be integrated into the video playback device 100, and replaces the corresponding display device mentioned above. That is, the video playback device 100 of this variation comprises the display module, and the display module comprises the specific display area mentioned above. Thus, the video playback device 100 of this variation is substantially a digital TV provided with the TV wall function.

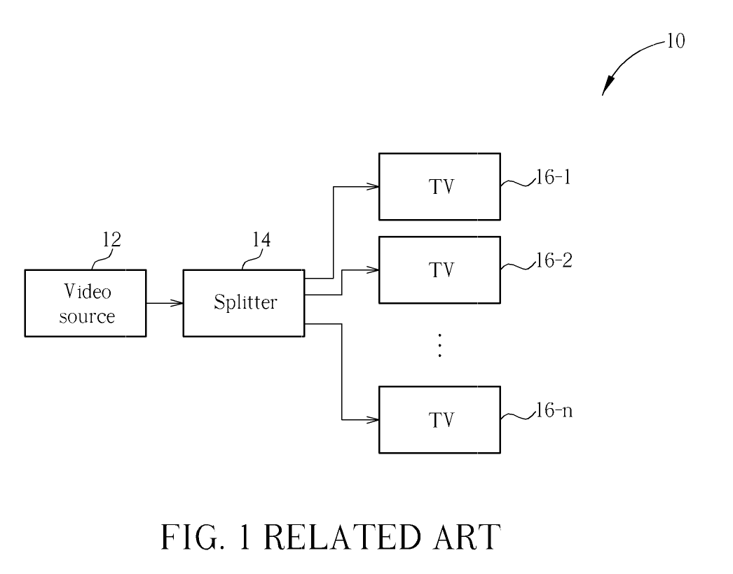

In practice, by switching an input path of the video processing module 120 to a signal source such as the video source 12 shown in FIG. 1, the video playback device 100 of this variation can be utilized as a display device with the TV wall function.

Therefore, when setting up a TV wall using a plurality of copies of the video playback device 100 of this variation (i.e., a plurality of copies the digital TV in this variation), no splitter such as that shown in FIG. 1 is required. The TV wall implemented according to the present invention can display an enlarged image of the same program without using the splitter 14 shown in FIG. 1, such as a broadcasting program received from the digital tuner 110 or a program received from the video source 12 shown in FIG. 1.

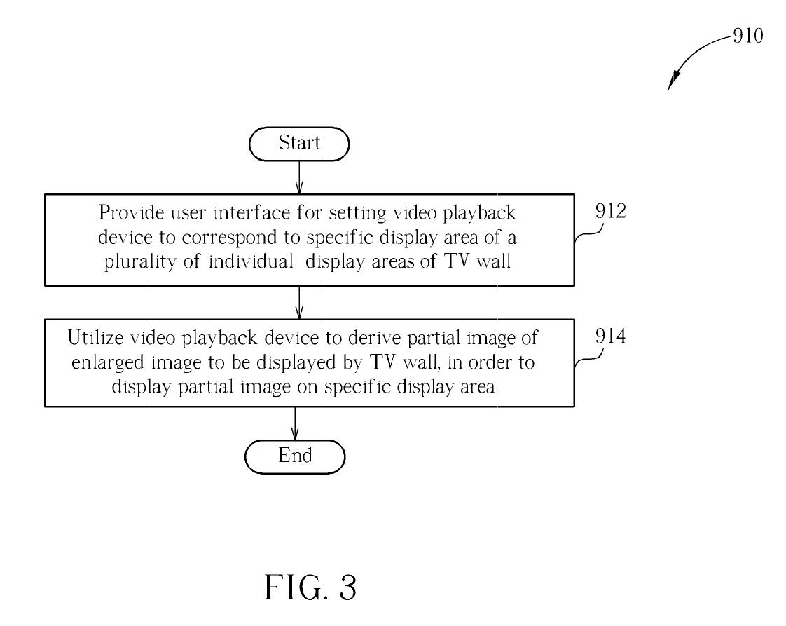

FIG. 3 is a flowchart of a method 910 for providing a video playback device with a TV wall function according to one embodiment of the present invention. The method 910 can be applied to the video playback device 100 shown in FIG. 2, and can be implemented by utilizing the video playback device 100 shown in FIG. 2. Thus, the method 910 is described as follows.

In Step 912, provide the user interface for setting the video playback device 100 to correspond to the specific display area of the plurality of individual display areas of the TV wall. In this embodiment, the controller 130 (e.g., the MCU executing the code 140C stored in the memory 140) is arranged to provide the user interface.

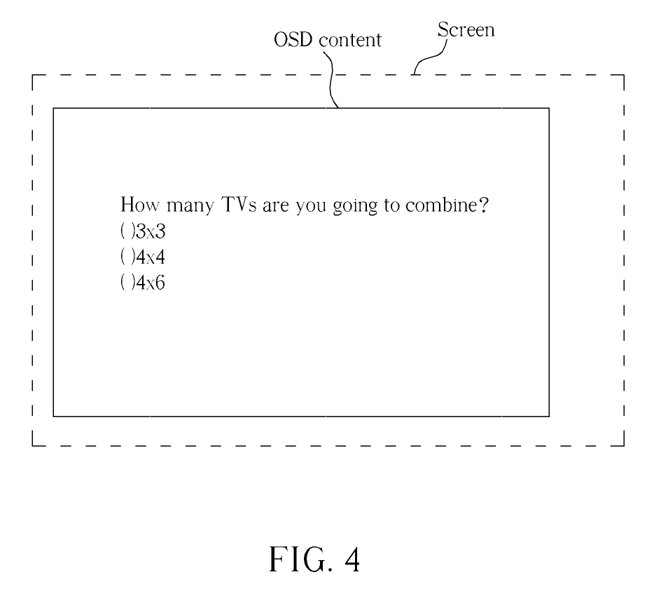

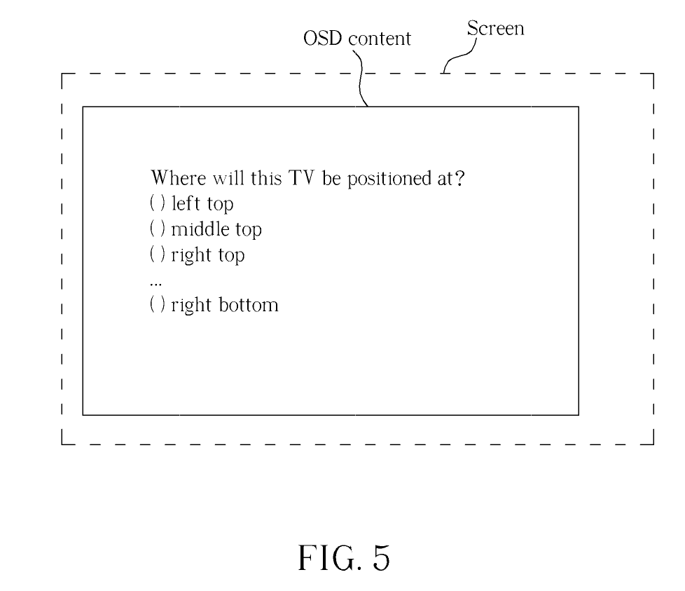

FIG. 4 and FIG. 5 illustrate examples of OSD contents to be displayed on a screen (e.g., the specific display area mentioned above) when utilizing the method shown in FIG. 3 to setup at least one portion of the TV wall. Referring to FIG. 4, a first menu of the user interface, such as the OSD content shown in FIG. 4, pops up. By listing a plurality of items to be selected (e.g., items labeled “3 by 3”, “4 by 4” and “4 by 6”, respectively), the user interface can be utilized for setting a number of individual display areas of the TV wall (e.g., 9, 16 or 24 corresponding to the items labeled “3 by 3”, “4 by 4” and “4 by 6”, respectively).

In addition, referring to FIG. 5, a second menu of the user interface, such as the OSD content shown in FIG. 5, pops up. By listing a plurality of items to be selected (e.g., items labeled “left top”, “middle top”, “right top”, . . . , and “right bottom”, respectively), the user interface can be utilized for setting which portion of the TV wall (e.g., the left top portion identified as the item labeled “left top”, the middle top portion identified as the item labeled “middle top”, the right top portion identified as the item labeled “right top”, . . . , or the right bottom portion identified as the item labeled “right bottom”) that the video playback device 100 corresponds to, i.e., the portion comprising the specific display area mentioned above.

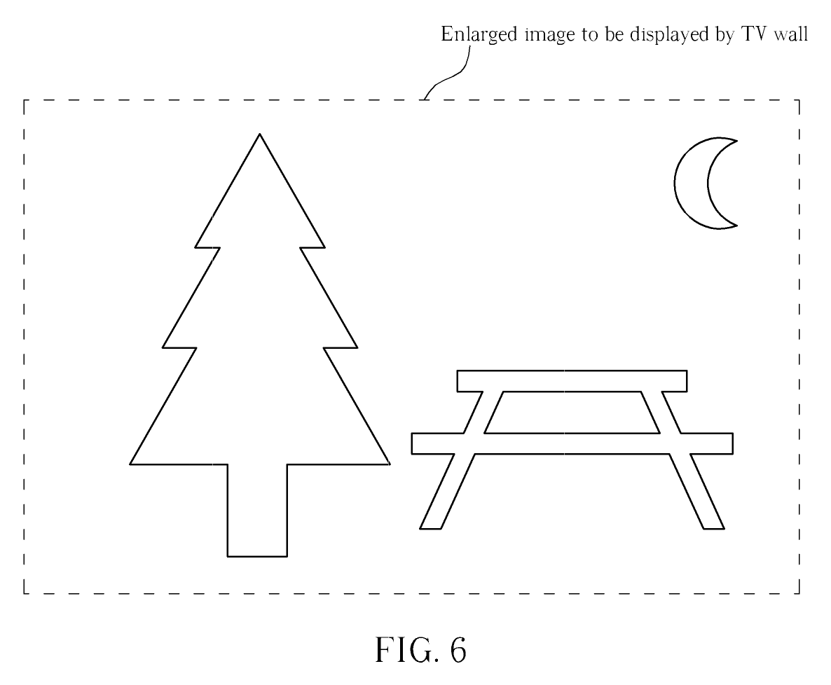

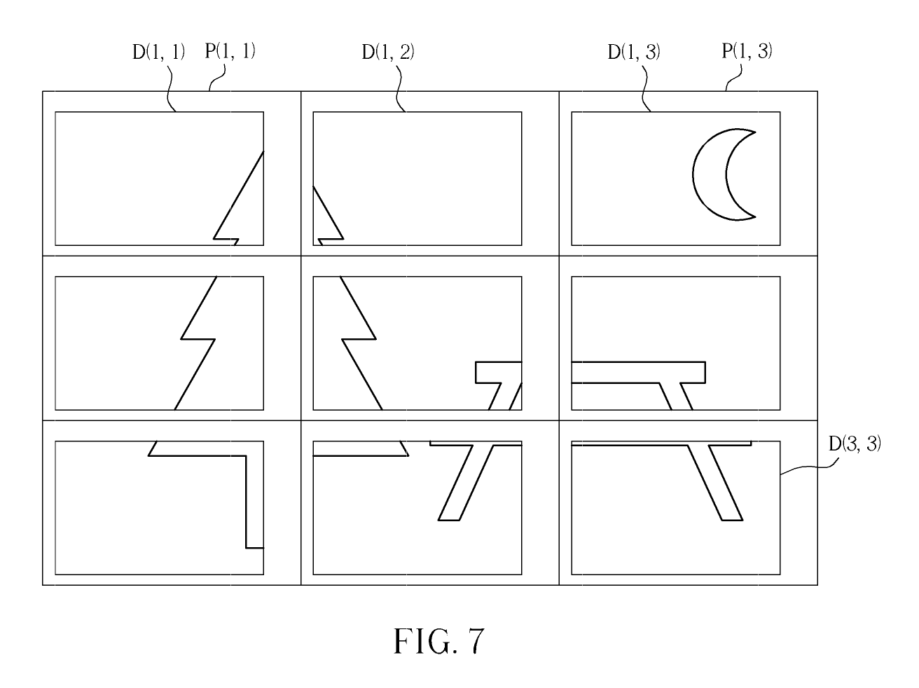

In Step 914, utilize the video playback device 100 to derive a partial image of the enlarged image to be displayed by the TV wall (e.g., the corresponding partial image of the enlarged image mentioned above), in order to display the partial image on the specific display area. For example, the item labeled “3 by 3” shown in FIG. 4 is selected from the first menu by the user or is selected according to a default setting. Referring to FIG. 6 and FIG. 7, more details of this step are further described as follows.

FIG. 6 illustrates an example of the enlarged image to be displayed by the TV wall. FIG. 7 illustrates examples of nine partial images of the enlarged image shown in FIG. 6. For example, when the user selects the item “right top” shown in FIG. 5 from the second menu, the video playback device 100 derives a partial image having a figure of the moon shown in FIG. 6, i.e., the partial image displayed on the display area D(1, 3) in the upper right portion P(1, 3) of the TV wall shown in FIG. 7. For example, when the user selects the item “left top” shown in FIG. 5 from the second menu, the video playback device 100 derives the partial image having a figure of the upper left portion of the tree shown in FIG. 6, i.e., the partial image displayed on the display area D(1, 1) in the upper left portion P(1, 1) of the TV wall shown in FIG. 7.

According to this embodiment, the video processing module 120 determines a respective location of the partial image with respect to the enlarged image according to a respective location of the specific display area D(I, J) with respect to the TV wall. Regarding the TV wall shown in FIG. 7, I=1, 2 or 3, and J=1, 2 or 3. In addition, the video processing module 120 determines a respective size of the partial image with respect to the enlarged image according to a number of individual display areas of the TV wall (e.g., 9, 16 or 24 corresponding to the items labeled “3 by 3”, “4 by 4” and “4 by 6”, respectively) and according to information relating to border widths of the specific display area, i.e., the widths of a plurality of borders enclosing the specific display area, where the border widths of the specific display area are predetermined values. Comparing the partial images shown in FIG. 7 with the enlarged image shown in 6, figures in regions corresponding all the borders outside the display areas D(1, 1), D(1, 2), D(1, 3), . . . , and D(3, 3) are blocked since the borders respectively enclosing the display areas D(1, 1), D(1, 2), D(1, 3), . . . , and D(3, 3) should occupy spaces of their own dimensions in order to derive correct display of the enlarged image by utilizing the TV wall.

According to a variation of this embodiment, some components of the video playback device 100 shown in FIG. 2 are integrated into an integrated circuit (IC) for controlling the video playback device 100 and for providing the video playback device 100 with the TV wall function. For example, the video processing module 120 and the controller 130 (i.e., the aforementioned MCU executing the code 140C stored in the memory 140) are integrated into the IC of this variation. Similar descriptions for this variation are not repeated in detail here.

In contrast to the related art, a TV wall implemented according to the present invention method and devices (e.g., an associated video playback device such as the video playback device 100, and an associated IC such as the aforementioned IC for controlling the video playback device 100 and for providing the video playback device 100 with the TV wall function) does not require a splitter such as that shown in FIG. 1. As a result, the overall cost of the TV wall is saved.

It is another advantage of the claimed invention that a TV wall implemented according to the present invention method and devices does not require connections corresponding to a star-style topology, such as those shown in FIG. 1. For example, when the number of individual display areas of the TV wall is nine, such as shown in FIG. 7, displaying an enlarged image of a source image from a video source requires only eight connections between adjacent portions of the TV wall (e.g., connections in series from the uppermost row comprising the portions P(1, 1) to P(1, 3)) through to the bottommost row). Therefore, when setting up the TV wall according to the present invention, complexity and inconvenience that occur in the related art can be avoided, where the cost of the cables required can also be saved.

Those skilled in the art will readily observe that numerous modifications and alterations of the device and method may be made while retaining the teachings of the invention.

What is claimed is:

1. A method for providing a video playback device with a television (TV) wall function, comprising:
providing a user interface for setting the video playback device to correspond to a specific display area of a plurality of individual display areas of a TV wall; and
utilizing the video playback device to derive a partial image of an enlarged image to be displayed by the TV wall, in order to display the partial image on the specific display area.

2. The method of claim 1, further comprising:
determining a respective location of the partial image with respect to the enlarged image according to a respective location of the specific display area with respect to the TV wall.

3. The method of claim 2, further comprising:
determining a respective size of the partial image with respect to the enlarged image according to a number of individual display areas of the TV wall and according to information relating to widths of a plurality of borders enclosing the specific display area.

4. The method of claim 1, further comprising:
utilizing the user interface to set a number of individual display areas of the TV wall.

5. The method of claim 1, wherein the video playback device comprises a display module comprising the specific display area.

6. The method of claim 5, wherein the video playback device is a TV provided with the TV wall function.

7. The method of claim 1, wherein the video playback device is a video source of a display device comprising the specific display area.

8. A video playback device provided with a television (TV) wall function, comprising:
a controller arranged to provide a user interface, wherein the user interface is utilized for setting the video playback device to correspond to a specific display area of a plurality of individual display areas of a TV wall; and
a video processing module arranged to derive a partial image of an enlarged image to be displayed by the TV wall, in order to display the partial image on the specific display area.

9. The video playback device of claim 8, wherein the video processing module determines a respective location of the partial image with respect to the enlarged image according to a respective location of the specific display area with respect to the TV wall.

10. The video playback device of claim 9, wherein the video processing module determines a respective size of the partial image with respect to the enlarged image according to a number of individual display areas of the TV wall and according to information relating to widths of a plurality of borders enclosing the specific display area.

11. The video playback device of claim 8, wherein the user interface is utilized for setting a number of individual display areas of the TV wall.

12. The video playback device of claim 8, wherein the video playback device comprises a display module comprising the specific display area.

13. The video playback device of claim 12, wherein the video playback device is a TV provided with the TV wall function.

14. The video playback device of claim 8, wherein the video playback device is a video source of a display device comprising the specific display area.

15. An integrated circuit (IC) for controlling a video playback device and providing the video playback device with a television (TV) wall function, comprising:
a controller arranged to provide a user interface, wherein the user interface is utilized for setting the video playback device to correspond to a specific display area of a plurality of individual display areas of a TV wall; and
a video processing module arranged to derive a partial image of an enlarged image to be displayed by the TV wall, in order to display the partial image on the specific display area.

16. The IC of claim 15, wherein the video processing module determines a respective location of the partial image with respect to the enlarged image according to a respective location of the specific display area with respect to the TV wall.

17. The IC of claim 16, wherein the video processing module determines a respective size of the partial image with respect to the enlarged image according to a number of individual display areas of the TV wall and according to information relating to widths of a plurality of borders enclosing the specific display area.

18. The IC of claim 15, wherein the user interface is utilized for setting a number of individual display areas of the TV wall.
